(19) United States
(12) Patent Application Publication
(10) Pub. No.: US 2007/0220282 A1
(43) Pub. Date: Sep. 20, 2007

(54) System and method for avoiding power shortage due to accidentally pressing power switch during BIOS update

(75) Inventor: Kun-Hung Huang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/378,111

(22) Filed: Mar. 17, 2006

(51) Int. Cl. G06F 1/26

(52) U.S. Cl. 713/300

(57) ABSTRACT

A system and method for avoiding power shortage due to accidentally pressing a power control switch during a BIOS update is provided. When a power control switch is turned on, a control chip module is actuated to send a preset signal to a control element module and a control signal to a power circuit module. Thereafter, the power circuit module sends an activating signal to the control element module. The control element module then electrically processes the activating signal from and the preset signal to generate an electrical signal for activating a power supply. During BIOS update, a BIOS update module continuously sends a GPIO control signal to the control chip module to replace the preset signal for maintaining activated power supply during the BIOS update, and sends a GPIO control change signal to the control chip module replace the GPIO control signal when the BIOS update is completed.

### FIELD OF THE INVENTION

The present invention relates to techniques for protecting BIOS update, and more particularly, to a method and system for avoiding power shortage due to accidentally pressing a power switch during BIOS update.

### BACKGROUND OF THE INVENTION

Along with advancement of technology, computers have become an indispensable tool in our life and are important information acquiring media. The demand for better performance has propelled the development of better computer systems, for example, CPUs, memories, hard disks and display card etc. are often upgraded to meet the demand. There are generally two types of peripheral upgrades: one is to replace old ones with new design/technology; the other is to upgrade an original BIOS (Basic Input/Output System) ROM and firmware to enhance work efficiency. For users, it is usually easier and cheaper to upgrade the BIOS. During BIOS update, if there is a shortage of power, data in the BIOS memory will not be updated completely, causing boot failure and activation failure of hardware components. There are many reasons that can result in a power shortage, one of the most commonly occurred reason is that the user accidentally presses the power button and thereby shuts down the power of a motherboard power activating circuit and causes BIOS update failure.

Referring to FIG. 1, shown is a block diagram of a conventional power activation scheme. As shown, pressing a power control switch 11 sends out a boot signal to the switch control chip 12. Then, the switch control chip 12 sends a power on signal to actuate the power circuit 13. The actuated power circuit 13 sends out a low potential signal to a power supply 15 to activate the power supply 15. If the power control switch 11 is pressed again, the switch control chip 12 will send out a power off signal to actuate the power circuit 13, which sends a high potential signal to the power supply 15 to turn it off. If this happens during BIOS update, it will result in BIOS update failure and the system cannot be booted.

In view of the above problem, dual BIOS system has been developed including a primary and a secondary BIOS memory, which allows the second BIOS to be activated if the primary BIOS update fails. However, this approach cannot prevent the failure of BIOS update under the circumstance of power shortage. Moreover, such approach requires an additional memory, and thereby increases cost of production and design complexity. Therefore, there is a need for a method and system for effectively avoiding power shortage due to accidentally pressing the power switch during the BIOS memory update.

### SUMMARY OF THE INVENTION

In the light of forgoing drawbacks, an objective of the present invention is to provide a method and system for avoiding power shortage due to accidentally pressing the power switch during a BIOS update without significant change to system power on/off circuit.

Another objective of the present invention is to provide a method and system for avoiding power shortage due to accidentally pressing the power switch during a BIOS update without the need for a backup memory.

In accordance with the above and other objectives, the present invention proposes a method and system for avoiding power shortage due to accidentally pressing a power control switch during a Basic Input/Output System (BIOS) update. The system comprises a control chip module for sending a preset signal and a control signal upon actuating by the power control switch turned on by a user; a power circuit module for sending an activating signal upon receiving the control signal sent by the control chip module; a control element module for electrically processing the activating signal from the power circuit module and the preset signal from the control chip module to generate an electrical signal for activating a power supply; and a BIOS update module for sending a GPIO control signal to the control chip module to replace the preset signal employed for maintaining activated power supply during the BIOS update, as well as a GPIO control change signal to the control chip module to replace the GPIO control signal when the BIOS update is completed.

In one embodiment, the control element module may be a microprocessor.

In yet another embodiment, the control element module may be a NOR logic gate; the GPIO control signal may be a high potential signal; the GPIO control change signal may be a low potential signal; the activating signal is a high potential signal and the electrical signal for activating the power supply may be a low potential signal.

The method for avoiding power shortage due to accidentally pressing a power control switch during a Basic Input/Output System (BIOS) update comprises the steps of sending a preset signal and a control signal from a control chip module actuated by the power control switch turned on by a user; sending an activating signal from a power circuit module upon receiving the control signal sent by the control chip module; electrically processing the activating signal from the power circuit module and the preset signal from the control chip module by a control element module to generate an electrical signal for activating a power supply; sending a General Port Input Output (GPIO) control signal from a BIOS update module to the control chip module to replace the preset signal and maintain continuous power supply during the BIOS update; and sending a GPIO control change signal to replace the GPIO control signal to the control chip module when the BIOS update is completed.

Accordingly, the method and system of the present application, for avoiding power shortage due to accidentally pressing the power switch during a BIOS update, allows the BIOS update to be completed and the memory data of the BIOS to be guarded without significant change to system power on/off circuit and without the need of a backup memory. Thus, for any device equipped with foregoing secure arrangement, incomplete of the BIOS update due to power shortage can be avoided in a simple and cost effective way.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) shows a block diagram of a conventional power activation scheme;

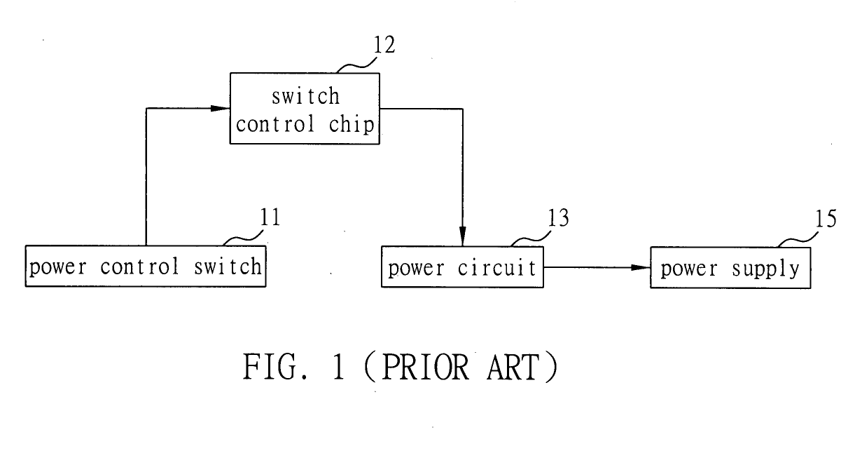

FIG. 2 is a flowchart of a method for avoiding power shortage due to accidentally pressing a power switch during BIOS update of the present invention; and

FIG. 3 is a block diagram of a system for avoiding power shortage due to accidentally pressing a power switch during BIOS update of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

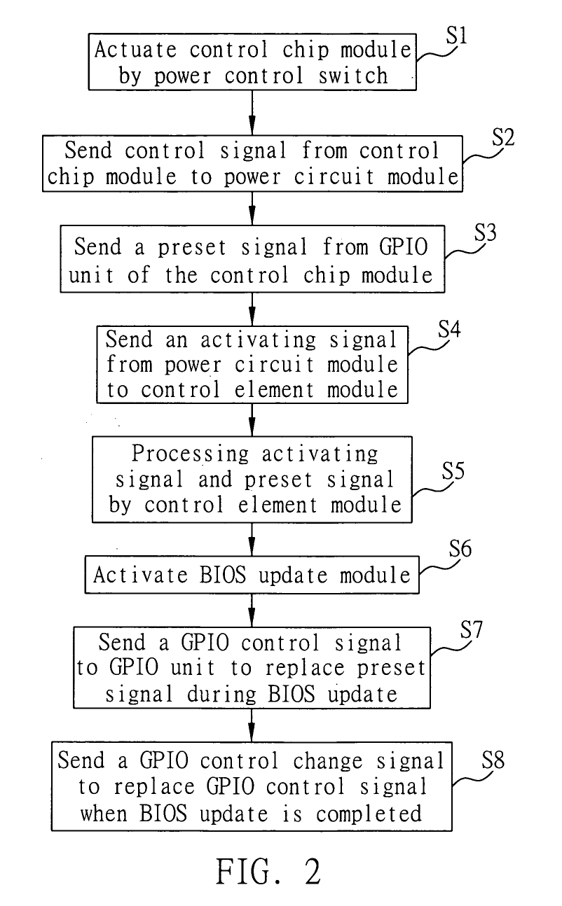

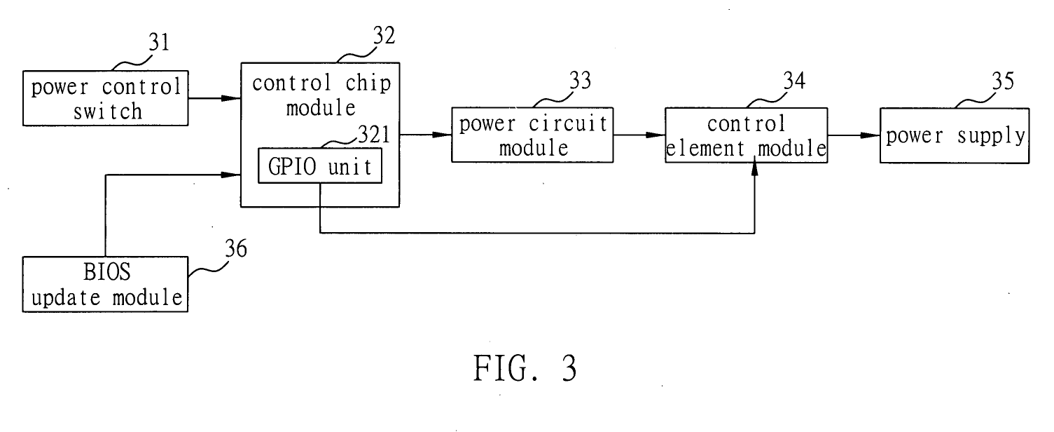

Referring now to FIG. 2 in conjunction with FIG. 3, shown are a flowchart of the method and a block diagram of the system for avoiding power shortage due to accidentally pressing the power switch during BIOS update of the present invention, respectively. As shown, the method for avoiding power shortage during BIOS update comprises the following steps:

In step S1, a power control switch 31 actuates a control chip module 32. Then, step S2 is performed.

In step S2, the control chip module 32 transmits a control signal to the power circuit module 33. Then, step S3 is performed.

In step S3, a GPIO unit 321 within the control chip module 32 sends out a preset signal, which is a low-potential signal. Then, step S4 is performed.

In step S4, the power circuit module 33, upon receiving the control signal sent by the control chip module 32, sends out a high-potential activating signal to a control element module 34. Then, step S5 is performed.

In step S5, the activating signal transmitted by the power circuit module 33 and the preset signal transmitted by the GPIO unit 321 are electrically processed by the control element module 34 to generate an electrical signal for activating a power supply 35. In this embodiment, the electrical process is a NOR logic gate process, in which a low-potential electrical signal is generated for turning on the power supply 35. Then, step S6 is performed.

In step S6, a BIOS update module 36 is activated for BIOS update. Next, step S7 is performed.

In step S7, the BIOS update module 36 sends a GPIO control signal to the GPIO unit 321 of the control chip module 32 to replace the preset signal during the BIOS update. In this embodiment, the GPIO control signal is a high-potential signal. Since the NOR logic gate is used, regardless of the potential of the activating signal (whether it is high or low), the electrical signal to the power supply 35 is always maintained at a low potential as long as the GPIO control signal is high. Thus, the power supply 35 can be maintained at an “ON” status during the BIOS update. Then, step S8 is performed.

In step S8, when the BIOS update has finished, the BIOS update module 36 then sends a GPIO control change signal to the control chip module 32 to replace the GPIO control signal. In this embodiment, the GPIO control change signal is a low signal. Thereafter, the power supply 35 is turned on/off based on the status of the activating signal, i.e. the power supply 35 is operated according to the power control switch.

Therefore, according to the method and system for avoiding power shortage during BIOS update, the BIOS memory can be updated safely avoiding power shortage due to accidentally pressing the power control switch, while requiring no significantly change to the system on/off circuits or addition of backup memories.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for avoiding power shortage due to accidentally pressing a power control switch during a Basic Input/Output System (BIOS) update, comprising:
sending a preset signal and a control signal from a control chip module actuated by the power control switch turned on by a user;
sending an activating signal from a power circuit module upon receiving the control signal sent by the control chip module;
electrically processing the activating signal from the power circuit module and the preset signal from the control chip module by a control element module to generate an electrical signal for activating a power supply;
sending a General Port Input Output (GPIO) control signal from a BIOS update module to the control chip module to replace the preset signal and maintain continuous power supply during the BIOS update; and
sending a GPIO control change signal to replace the GPIO control signal to the control chip module when the BIOS update is completed.

2. The method for avoiding power shortage due to accidentally pressing a power switch during a BIOS update of claim 1, wherein the preset signal is an initial value sent out from a GPIO unit of the control chip module.

3. The method for avoiding power shortage due to accidentally pressing a power switch during a BIOS update of claim 1, wherein the control element module is one of a microprocessor and a logic gate.

4. The method for avoiding power shortage due to accidentally pressing a power switch during a BIOS update of claim 3, wherein the logic gate is a NOR gate.

5. The method for avoiding power shortage due to accidentally pressing a power switch during a BIOS update of claim 4, wherein the GPIO control signal is a high potential signal.

6. The method for avoiding power shortage due to accidentally pressing a power switch during a BIOS update of claim 4, wherein the GPIO control change signal is a low potential signal.

7. The method for avoiding power shortage due to accidentally pressing a power switch during a BIOS update of claim 4, wherein the activating signal is high when the power control switch is turned on by the user and is low when the power control switch is turned off by the user.

8. The method for avoiding power shortage due to accidentally pressing a power switch during a BIOS update of claim 4, wherein the power supply is activated by the electrical signal at a low potential.

9. A system for avoiding power shortage due to accidentally pressing a power control switch during a Basic Input/Output System (BIOS) update, comprising:
a control chip module for sending a preset signal and a control signal upon actuating by the power control switch turned on by a user;
a power circuit module for sending an activating signal upon receiving the control signal sent by the control chip module;
a control element module for electrically processing the activating signal from the power circuit module and the preset signal from the control chip module to generate an electrical signal for activating a power supply; and
a BIOS update module for sending a GPIO control signal to the control chip module to replace the preset signal for maintaining activated power supply during the BIOS update, and sending a GPIO control change signal to the control chip module replace the GPIO control signal when the BIOS update is completed.

10. The system for avoiding power shortage due to accidentally pressing a power switch during a BIOS update of claim 9, wherein the preset signal is an initial value sent out from a GPIO unit of the control chip module.

11. The system for avoiding power shortage due to accidentally pressing a power switch during a BIOS update of claim 9, wherein the control element module is one of a microprocessor and a logic gate.

12. The system for avoiding power shortage due to accidentally pressing a power switch during a BIOS update of claim 11, wherein the logic gate is a NOR gate.

13. The system for avoiding power shortage due to accidentally pressing a power switch during a BIOS update of claim 12, wherein the GPIO control signal is a high potential signal.

14. The system for avoiding power shortage due to accidentally pressing a power switch during a BIOS update of claim 12, wherein the GPIO control change signal is a low potential signal.

15. The system for avoiding power shortage due to accidentally pressing a power switch during a BIOS update of claim 12, wherein the activating signal is high when the power control switch is turned on by the user and is low when the power control switch is turned off by the user.

16. The system for avoiding power shortage due to accidentally pressing a power switch during a BIOS update of claim 12, wherein the power supply is activated by the electrical signal at a low potential.
